(19) United States
(12) Patent Application Publication
(10) Pub. No.: US 2016/0364997 A1
(43) Pub. Date: Dec. 15, 2016

(54) ASSESSING LEARNING OF USERS

(71) Applicant: MOORE THEOLOGICAL COLLEGE COUNCIL, New South Wales (AU)

(72) Inventor: Shane Waugh, New South Wales (AU)

(73) Assignee: MOORE THEOLOGICAL COLLEGE COUNCIL, New South Wales (AU)

(21) Appl. No.: 15/250,034

(22) Filed: Aug. 29, 2016

Related U.S. Application Data
(63) Continuation of application No. PCT/AU2015/050031, filed on Jan. 30, 2015.

(30) Foreign Application Priority Data
Feb. 27, 2014 (AU) 2014900643

(51) Int. Cl. G09B 7/10

(52) U.S. Cl. CPC G09B 7/10

(57) ABSTRACT

This disclosure is related to assessing learning of users and in particular, to assess other knowledge than fact knowledge. A computer system for assessing learning of a user includes an input module to receive from the user a first indication associated with each of multiple electronic evidence items of a relationship between that electronic evidence item and a theory, and a second indication of whether the theory is correct. The system further includes a processor to determine a learning credit for the second indication based on the first indication associated with each electronic evidence item and the second indication, and to store on a data store assessment data indicative of the learning credit awarded to the user. A user may choose the wrong answer for whether the theory is correct but if this answer is consistent with the assessment of the evidence items, a learning credit can still be awarded.

### CROSS-REFERENCE TO RELATED APPLICATIONS

This application is a continuation of International Application No. PCT/AU2015/050031, filed on Jan. 30, 2015, which claims the benefit of AU 2014900643, filed on Feb. 27, 2014. The disclosures of the above applications are incorporated herein by reference.

### FIELD

The present disclosure relates to assessing learning of users.

### BACKGROUND

The statements in this section merely provide background information related to the present disclosure and may not constitute prior art.

Students use e-learning services to download course materials, interact with other students and test their learning by answering multiple choice questions. While multiple choice questions give a teacher, such as a professor, a good indication of the student's knowledge of facts, this question format has significant disadvantages. One disadvantage is that it is difficult for the teacher to assess other than fact knowledge.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to the teachings of the present disclosure, a computer system for assessing learning of a user is provided that comprises, in one form:

an input module to receive from the user

a first indication associated with each of multiple electronic evidence items of a relationship between that electronic evidence item and a theory, and

a second indication of whether the theory is correct; and

a processor

to determine a learning credit for the second indication based on the first indication associated with each electronic evidence item and the second indication, and

to store on a data store assessment data indicative of the learning credit awarded to the user.

Since the learning credit is determined based on the indication of the relationship between the evidence items and the theory, the determined learning credit provides more information than a simple right or wrong. For example, a user may choose the wrong answer for whether the theory is correct but if this answer is consistent with the assessment of the evidence items, a learning credit can still be awarded. This is an advantage over other methods which only award points if the answer as correct and award no points if the answer is wrong.

The input module may further receive a selection of a first of the multiple electronic evidence items and to determine the learning credit is based on the selection of the first of the evidence items.

It is an advantage that based on the selection of an evidence item the processor can determine whether the user has based the conclusion of the correctness of the theory reflected by the second indication on an evidence item that the user has judged consistently with that conclusion.

The computer system may further comprise a database to store a third indication associated with each of the multiple electronic evidence items of the relationship between that electronic evidence item and the theory, and a fourth indication of whether the theory is correct, wherein to determine the learning credit is based on the third indication associated with each of the multiple electronic evidence documents and the fourth indication.

The processor may further determine whether the second indication is different from the fourth indication and to determine the learning credit is based on whether the second indication is different from the fourth indication.

The processor may further identify a second of the multiple electronic evidence items where the first indication is different from the third indication and determine the learning credit is based on the second of the multiple electronic evidence items.

The processor may further determine that the first of the multiple electronic evidence items is identical to the second of the multiple electronic evidence items and determine the learning credit is responsive to determining that the second indication is different from the fourth indication and that the first of the multiple electronic evidence items is identical to the second of the multiple electronic evidence items.

If the user selects the wrong answer for the correctness of the theory, a learning credit can still be awarded if the user selects an evidence item which the user has assessed incorrectly. This allows more granular learning credits which is an advantage over other methods that only allow credit or no credit.

The database may further store an importance indication associated with each of the multiple electronic evidence items and to determine the learning credit may be based on the importance indication.

The first indication of the relationship may have one of multiple indication values and the multiple indication values may comprise:

a first indication value indicating that the electronic evidence item confirms the theory;

a second indication value indicating that the electronic evidence item disconfirms the theory; and

a third indication value indicating that the electronic evidence item is not related to the theory.

A computer implemented method for assessing learning of a user comprises:

receiving from the user

a first indication associated with each of multiple electronic evidence items of a relationship between that electronic evidence item and a theory, and

a second indication of whether the theory is correct;

determining a learning credit for the second indication based on the first indication associated with each electronic evidence item and the second indication;

and

storing on a data store assessment data indicative of the learning credit awarded to the user.

Software, when installed on a computer, causes the computer to perform the method above.

A computer system for generating a user interface to assess learning of a user comprises:

an input data port to receive multiple electronic evidence items and an electronic representation of a theory;

a processor to generate a user interface, the user interface comprising

a representation of the multiple electronic evidence items and the theory;

a first user control element associated with each of the multiple electronic evidence items to allow the user to provide a first indication of a relationship between that electronic evidence item and a theory, and

a second user control element associated with the theory to allow the user to provide a second indication of whether the theory is correct; and

an output data port to send the first indication associated with each of the multiple electronic evidence items and the second indication to an assessment computer system.

The user interface may further comprise a third user control element to allow the user to provide a selection of one of the multiple electronic evidence items.

A computer implemented method for generating a user interface to assess learning of a user comprises:

receiving multiple electronic evidence items and an electronic representation of a theory;

generating a user interface comprising

a representation of the multiple electronic evidence items and the theory;

a first user control element associated with each of the multiple electronic evidence items to allow the user to provide a first indication of a relationship between that electronic evidence item and a theory, and

a second user control element associated with the theory to allow the user to provide a second indication of whether the theory is correct; and

sending the first indication associated with each of the multiple electronic evidence items and the second indication to an assessment computer system.

Software, when installed on a computer, causes the computer to perform the above method for generating a user interface to assess learning of a user.

Optional features described of any aspect of method, computer readable medium or computer system, where appropriate, similarly apply to the other aspects also described here.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

A non-limiting example will now be described with reference to the figures, wherein:

FIG. 1 illustrates a computer system for assessing learning of a user;

FIG. 2 illustrates a method for assessing learning progress of a user;

FIG. 3 illustrates a user interface;

FIG. 4 illustrates an example of an instruction provided to the user before answering the questions;

FIG. 5 illustrates a computer system for generating a user interface; and

FIG. 6 illustrates a computer implemented method for generating a user interface.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One feature of many learning environments is that the learning of the users of these environments is assessed regularly. Although the following examples are in the context of the humanities, such as theology, there may be application examples in more technical disciplines where complex evidence needs to be assessed and problem solving skills are considered to be important. Other examples are economics and science.

Further, in medical training the conclusions of a practitioner are often based on evidence items, such as symptoms presented by the patient. For example, the theory that the patient suffered from a stroke may be confirmed by some symptoms but other symptoms may be unspecific. Training a doctor to work in an emergency department may comprise presenting the doctor with the evidence items, such as symptoms, and one or more theories, such as medical conditions. The doctor learns how to apply to evidence to the theories and is assessed on their learning.

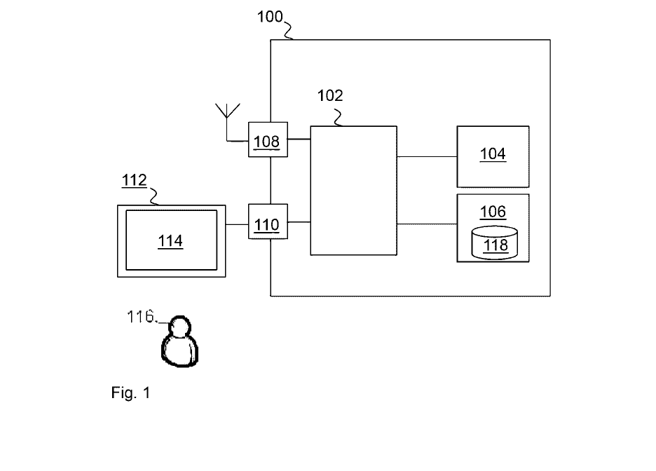

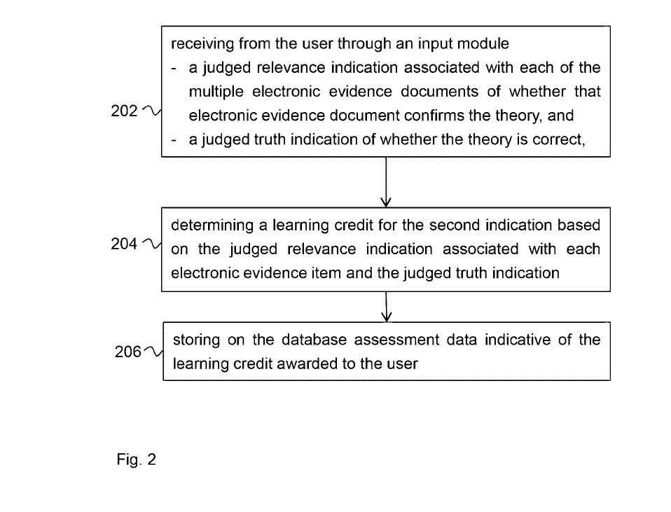

FIG. 1 illustrates a computer system 100 for assessing learning of a user. The computer system 100 comprises a processor 102 connected to a program memory 104, a data memory 106, a communication port 108 and a user port 110 connected to display device 112. The program memory 104 is a non-transitory computer readable medium, such as a hard drive, a solid state disk or CD-ROM. Software, that is an executable program, stored on program memory 104 causes the processor 102 to perform the method in FIG. 2, that is, the processor 102 determines and stores a learning credit indicative of the learning progress of the user. For example, the learning credit may be stored as ASCII characters or numerical values in a database 118, such as an SQL database.

The processor 102 may receive data, such as indications of a relationship between an electronic evidence item and a theory, through several input modules, such as a memory interface to data memory 106 as well as communications port 108 and user port 110, which is connected to a screen 112 that shows a visual representation 114 of the assessment to a teacher 116. In one example, the processor 102 sends a request for such answers from the user to a server 120 and receives answers from server 120 via communications port 108, such as by using a Wi-Fi network according to IEEE 802.11, 3G, the Internet or any combination thereof. The Wi-Fi network may be a decentralized ad-hoc network, such that no dedicated management infrastructure, such as a router, is required or a centralized network with a router or access point managing the network.

Although communications port 108 and user port 110 are shown as distinct entities, it is to be understood that any kind of input module may be used to receive data, such as a network connection, a memory interface, a pin of the chip package of processor 102, or logical ports, such as IP sockets or parameters of functions stored on program memory 104 and executed by processor 102. These parameters may be stored on data memory 106 and may be handled by-value or by-reference, that is, as a pointer, in the source code.

The processor 102 may receive data through all these input modules, which includes memory access of volatile memory, such as cache or RAM, or non-volatile memory, such as an optical disk drive, hard disk drive, storage server or cloud storage.

It is to be understood that any receiving step may be preceded by the processor 102 determining or computing the data that is later received. For example, the processor 102 determines an indication of a relationship between an electronic evidence item and the theory and stores the indication in data memory 106, such as RAM or a processor register. The processor 102 then requests the indication from the data memory 106, such as by providing a read signal together with a memory address. The data memory 106 provides the requested data as a voltage signal on a physical bit line and the processor 102 receives the summary via a memory interface.

In one example, a database 118 resides on data memory 106 and stores data that is provided by the teacher who sets up the assessment for a particular learning unit, such as a particular topic of a university course. In one example, computer system 100 hosts an instance of the Moodie e-learning environment and the database 118 is the Moodie database. The database can be accessed using the access functions provided by Moodie.

Database 118 may store an actual relevance indication associated with each of multiple electronic evidence items. Each of these actual relevance indications is indicative of a relationship between the respective evidence item and a theory. For example, the actual relevance indication may be indicative of whether the respective evidence item confirms a theory. A variety of different types of evidence items may be used and these evidence items may also be stored on database 118. For example, an evidence item may be an evidence document, such as a PDF or text file, or a link to such a document. An evidence item may also be a text string displayed to the user that may be embedded into a website as <div> sections.

The electronic evidence items may also be stored elsewhere. In that example the database simply stores a reference to the evidence item together with the indication. In one example, the reference is a bibliographic reference to the Bible, such as “Lev 20: 1-3”. The terms ‘evidence document’ and ‘evidence item’ are used herein interchangeably unless noted otherwise. The term ‘electronic’ in the context of electronic evidence items means that the evidence items are electronically represented, such as in the form of a number of bytes on a hard disk drive, database, cloud storage or transported over the Internet or internally in a computer hardware or processor 102. This may also comprise adding a cyclic redundancy check number, encrypting or cryptographically signing the evidence item.

In one example, the actual relevance indication has one of three possible indication values: Use, Ignore, Avoid. In case the actual relevance indication is set as “Use”, the teacher considers that evidence item confirms the theory. In case the actual relevance indication is set as “Ignore”, the teacher considers that evidence item is not related to this theory. In case the actual relevance indication is set as “Avoid”, the teacher considers that evidence item disconfirms the theory. In another example the term “Refute” is used instead of “Avoid”.

The actual relevance indication may be encoded in database 118 as two bits, such that 01 represents “Use”, 00 represents “Ignore” and 10 represents “Avoid”. The database 118 may comprise a table named “Actual_relevance” with data columns “document_ID” (integer), “document reference” (string), “indication” (two bit Boolean).

The database 118 may further store an actual truth indication of whether the theory is correct or true. For example, the teacher sets the actual truth indication as “True” or 1 because the teacher considers the theory is correct. In one example, the theory is a text string or a vector of ASCII characters that is also stored on database 118. In that case, database 118 may comprise a table named “theories” with data columns “theory_ID” (integer), “correctness” (Boolean) and “theory_text” (string).

FIG. 2 illustrates a computer implemented method 200 method for assessing learning of a user as performed by processor 102. Processor 102 receives 202 from the user a judged relevance indication associated with each of multiple electronic evidence items of how the user considers the relationship between that electronic evidence item and a theory and also receives a judged truth indication of whether the user considers that the theory is correct. The judged relevance indication may also be an indication of whether the electronic evidence document confirms a theory. The same indication values may be used for the judged relevance indication as for the actual relevance indication as described above.

The processor 102 then determines 204 a learning credit for the judged truth indication based on the judged relevance indication associated with each electronic evidence item and the judged truth indication. Next, processor 102 stores 206 on a data store assessment data indicative of the learning credit awarded to the user.

Processor may further receive from database 118 an actual relevance indication associated with each of multiple electronic evidence items of whether that electronic evidence item confirms a theory. Processor 102 may also receive from the database 118 an actual truth indication of whether the theory is correct.

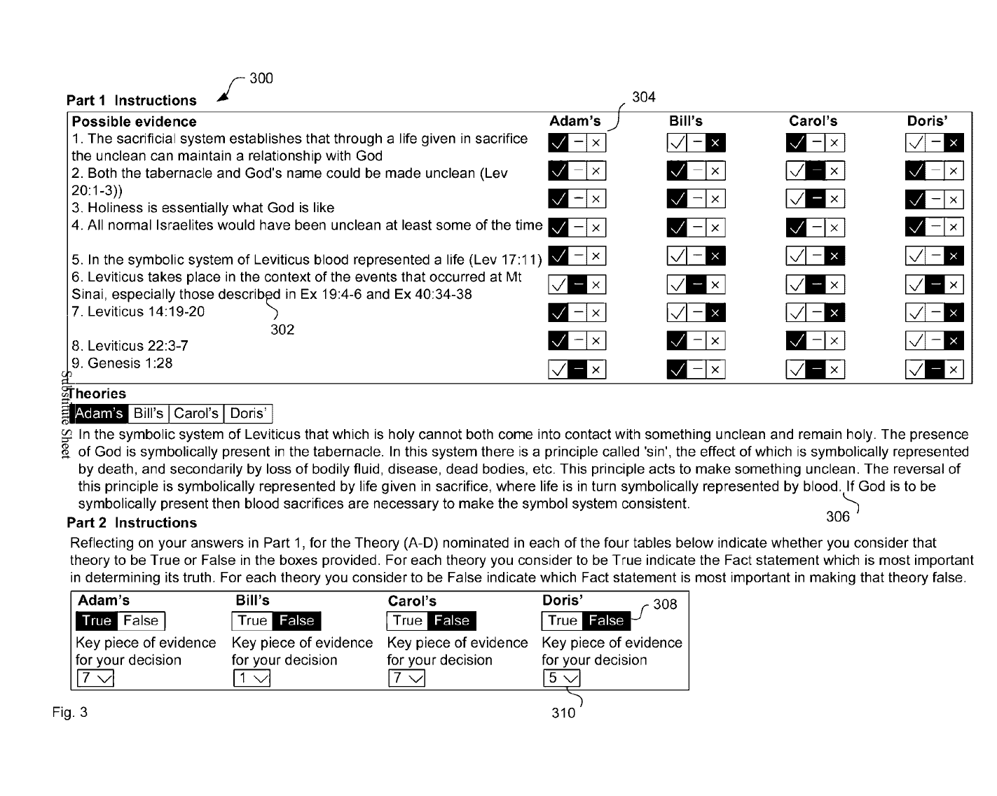

FIG. 3 illustrates a user interface 300 as generated by processor 102 and presented to the user. In one example, the user interface 300 is a dynamically created HTML page with AJAX functionality. The user interface 300 comprises references to multiple evidence items, such as first example evidence item 302, which is a text string in the example of FIG. 3. User interface 300 further comprises an input element 304 and a theory text box 306. The input element 304 allows the user to provide the judged relevance indication associated with the first electronic evidence item 302 of a relationship between that electronic evidence item 302 and the theory 306, such as whether that electronic evidence item 302 confirms the theory 306. In the example of FIG. 3, the user has selected that the first evidence item 302 confirms the theory 306.

The user interface 300 further comprises a theory conclusion element 308 to allow the user to provide the judged truth indication of whether the theory 306 is correct and a drop down list 310 to provide a selection of a first of the multiple electronic evidence items.

The user interface 300 may comprise a ‘Submit’ button (not shown) to initiate data transfer of the answer to the computer system 100 in FIG. 1.

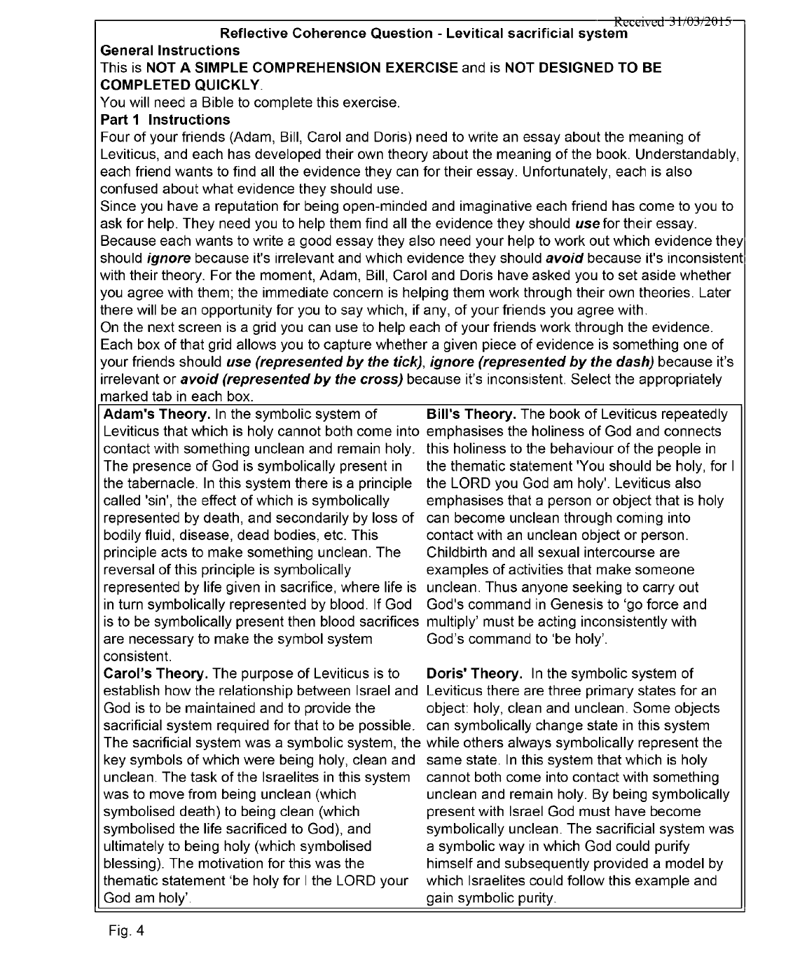

FIG. 4 illustrates an example of an instruction provided to the user before answering the questions.

As mentioned above, computer system 100 comprises communications port 108 to receive data, such that the communications port 108 operates as an input module to receive data from a user. This data is indicative of the answers that the user has given in the user interface 300. For example, the user interface 300 is implemented as a webpage based on Asynchronous JavaScript and XML (AJAX) and the data is received via a XMLHttpRequest object as soon as the user provides an answer.

Through this or other input modules processor 102 receives the judged relevance indication associated with each of the multiple electronic evidence items. The judged relevance indication is indicative of whether that electronic evidence item confirms the theory and reflects the user's opinion of whether that electronic evidence item confirms the theory or not. For example, the user interface presents the first evidence item as a text reference to a section in the Bible and has three buttons for ‘Use’, ‘Ignore’ and ‘Avoid’, respectively. When the user selects one of the three buttons, the respective value, such as 01, 00 or 10, is transferred to processor 102 as the judged relevance indication.

The user interface further comprises a button for the user to select whether the user considers the theory correct or not. Selecting that button causes the judged truth indication of whether the theory is correct to be sent to processor 102. Processor 102 receives the judged truth indication as described above.

The user interface also comprises a control element, such as a drop down list that allows the user to select one of the multiple electronic evidence items. Although only one evidence item is selected in the following examples, it is to be understood that it is also possible to select multiple electronic evidence items.

The selected evidence item is the evidence item which the user considers most relevant for the conclusion of the correctness of the theory. Each electronic evidence item has an item identifier and each entry of the drop down list also has the item identifier as a value of the respective list elements. When the user selects one of the evidence items, the corresponding identifier is sent to the computer system 100. Processor 102 receives the selection, that is, the item identifier, of the selected electronic evidence item via the input module.

Once the user has answered all questions and the processor 102 has received all data relating to the answers, the processor 102 determines a learning credit indicative of the learning progress of the user based on the user's answers. That is, processor 102 determines the learning credit based on the judged relevance indications and the judged truth indication.

In one example, this determination is further based on the actual relevance indication and the actual truth indication provided by the teacher and stored on database 118. The learning credit may be of a variety of different forms. In one example, the learning credit is a point value and determining the learning credit comprises determining whether the user is awarded one or more points, no points or taken points away from. In another example, the learning credit is composed of marks for two stages:

Stage 1:

S1_mark is the mark awarded for correctly assessing the evidential relationship between a given Theory and evidence statement.

Stage 2:

S2a_mark is the mark awarded for correctly assessing the truth status of a Theory.

S2b_max_mark is the mark awarded for having a completely coherence selection of evidence and truth assessment of the given Theory.

S2b_mid_mark is the mark awarded for having a partially coherent selection of evidence and truth assessment of the given Theory.

S2b_bad_mark is the mark awarded for their being negative coherence in the selection of evidence and truth assessment of the given Theory.

S2b_low_mark is the mark awarded for their being minimal coherence in the selection of evidence and truth assessment of the given Theory. It is a small negative mark.

S2b_very_bad_mark is the mark awarded for their being strong negative coherence in the selection of evidence and truth assessment of the given Theory. It is a large negative mark.

Each of the different labels above can be related to a number value in order to add multiple different questions of the same or different type and to make a final pass or fail decision. In another example, the different labels above are related to feedback text such that feedback can be given to the user automatically without the teacher having to manually assess the answers of the student.

Finally, the processor 102 stores on the database 118 assessment data indicative of the learning credit awarded to the user. The processor 102 may store the assessment data in form of the labels above as strings, in form of an encoded representation of the labels, such as a 3 bit label identifier or as a cumulative points value. If database 118 already contains a points value associated with that user, processor 102 stores the data indicative of the learning credit by adding the newly awarded points to the existing points.

The following description will provide more details on a particular example for using the above computer system to determine a learning credit based on answers of Reflective Coherence Questions (RCQ).

Reflective Coherence Question is composed of theories and electronic evidence items that may be used to support the provided theories. In Stage 1 of the question a learner is presented with a scenario in which the learner decides on the relationship between each theory and each electronic evidence item.

The way in which the learner provides the answers implicitly defines the criteria by which the relationships and evidence are assessed. In the initial interactions with Stage 1 the learner is responding to content provided by the teacher.

In Stage 2 the learner reflects on the pattern of relationships developed as a result of completing Stage 1. Specifically, the learner interprets their own contribution to the exercise itself and, on the basis of this interpretation, comes to an assessment of the original theories with which the exercise started. In this assessment the learner identifies each theory as true/acceptable, identifies the most important reasons for this judgement and ranks these reasons in order of importance. At the end of the exercise they have moved beyond an answer based merely on recall or intuition and to a reasoned position arrived at as the result of reflection on their own understanding of the question. The coherence of this reflective response can be assessed by comparing the pattern of answers in Stage 1 with that in Stage 2.

Even though Stage 1 of the RCQ is composed of individual components, the answers are structured and displayed so as to allow the learner to see and reflect on their own pattern of answers. Because of the common features among the individual components in this pattern the pattern itself a meaningful whole, reflection on which can be meaningfully assessed.

This pattern of answers is also the learner's original contribution; the exact pattern is difficult for the teacher to predict in advance. Nevertheless, the logic used to mark Stage 2 (which is coded into the question format itself) is sufficiently advanced that any answer can be assessed using three distinct criteria: correctness, consistency and coherence. Further, as correctness is only one feature of the marking calculation by processor 102, it is possible to have answers that are not ‘correct’ but for which processor 102 still determines very high marks due to other properties of consistency or coherence. As a result rather than answers being simply right or wrong answers will fall on a spectrum ranging from optimal to poor.

Using RCQ the learner is required to reflect on and interpret something they have produced which the teacher may not have predicted and provide reasons for their answers. The learner is thus being assessed not just on how close their view conforms to that of the teacher (although that is important), they are also being assessed on whether they have integrated their own views into one coherent whole, independently of whether that view is the same as that of the teacher. In this way the RCQ format circumvents the key weakness of other assessment methods by allowing the student to see and reflect on (and gain marks from reflecting on) content that they have provided and to provide reasons for their answers.

Theories

In one example, database 118 stores four theories, although the number of theories can be reduced to two and could reach as high as six. However, in other examples, more than six theories may be used. With each theory, database 118 may store a theory text string of a length between 50-100 words. Theories are tailored to a specific learning outcome and must be carefully selected.

Electronic Evidence Items

In one example, database 118 stores nine electronic evidence items, such as evidence statements, each being around 20 words in length. There may be around two evidence claims per theory used. Evidence claims are chosen such that if a learner answers optimally even the false theories will have some supporting evidence, with evidence claims being tailored so that each clearly supports or conflicts with at least one, but not every, theory. In one example, all pieces of evidence are deemed to be true for the purpose of the exercise—the evidence provides an anchor for the learner. In different examples, however, one or more pieces of evidence may be false and the student is further tested on whether the student recognizes the false evidence.

Relationships between theory and evidence items (e.g. indication of whether the electronic evidence item confirms a theory)

Answering the question a student nominates what kind of relationship there is between the theory and the evidence. The indication, which is referred to as ‘first’ and ‘third’ indication above, may have one of three possible values representing respective relationships defined for the evidence items.
Confirming: this evidence item makes it more likely that the theory is true
Not related: this evidence item makes the theory neither more nor less likely to be true
Disconfirming: this evidence item makes it more likely for the theory to be false

Note: the exercise itself used less technical and confronting terminology for these relationships by presenting the decisions learners make in a familiar relational context.

It is noted that the above values already include the correctness of the evidence items. For example, an evidence item may be a statement that by itself would confirm the theory but that statement is false. In that case the indication value is not ‘Confirming’ but ‘Not Related’ or Disconfirming′ as set by the teacher. As mentioned above, another possible indication value may be ‘Refute’ in case the evidence is false.

Answering Process (Receiving Indications from the User)

Stage 1

After reading and understanding the presented theories the answering process begins with a learner defining the relationship between each theory-evidence pair. This way, the learning provides the third indication associated with each of the multiple electronic evidence items of whether that electronic evidence item confirms the theory.

In one example, answers are marked on a grid. Theories are arranged in columns, evidence items in rows. Learners can elect to work within a column (and so stay within a theory) or within a row (and so assess each theory against the fixed point of the evidence in turn) or switch between theories and rows as it is convenient to do so. Only one theory is displayed at a time but students can easily switch which theory is displayed. Being able to see all their answers simultaneously is advantageous for the learner. Answers to individual theory-evidence pairs are indicated with clear visual cues and eventually form an overall pattern of answers.

Stage 2

With a pattern of answers now constructed a learner is directed away from the theories and evidence provided by the teacher and focused on their own answers. Learners are required to reflect on their Stage 1 responses and indicate:

Truth of the theory: Learners provide the fourth indication of whether they regard each theory to be true

Key evidence: Learners provide the selection of the three most important pieces of evidence they considered when coming to their answer

Learning Outcomes (following—and extending—Bloom's popular taxonomy)

Knowledge and Comprehension

These are implicit in the exercise but are not a significant focus. Learners are assumed to be able to comprehend the presented theories and to have sufficient background knowledge of the relevant content to make sense of both the theories and the relevance of the evidence.

Application

Presenting students with unfamiliar theories in the context of evidence the truth of which can be safely taken for granted allows for Stage 1 of the exercise to include a component of application; learners must apply evidence with which they are familiar to theories which are new.

Analysis

Stage 1 requires significant analysis of the presented theories as the relationship between each theory-evidence pair is interrogated. In an example RCQ there may be more than 30 such pairs and answers may frequently not be initially obvious, meaning that the analysis is at a higher level and has a pronounced evaluative component. Identifying the most important evidence in Stage also requires analysis and evaluation.

Synthesis

Stage 2 requires synthesis as learners reflect on their pattern of answers from Stage 1 in light of the truth or falsity of the provided theories. Here they must decide how much weight to attach to confirming, irrelevant and disconfirming evidence and assess the theory in light of the evidence.

Evaluation

Judgements of truth in light of evidence and the ranking of evidence by importance are paradigm cases of evaluative thought. What makes this even more noteworthy is that what the learner is here evaluating is the pattern of their own previous answers, meaning that the evaluation here has a strong reflective component which is unusual for an automatically marked assessment tool.

Overall, it is clear that the learning outcomes for the RCQ are biased towards the upper end of Bloom's taxonomy. This means that for a full assessment RCQ's should be paired with MCQ that are better suited to testing the lower levels of Bloom's taxonomy. Initial testing suggests that the RCQ is biased more heavily towards the upper end of Bloom's taxonomy than short essays written under time pressure.

Marking

Stage 1

In most cases a teacher will define an ideal answer for each theory-evidence pair, which is stored on database 118 as the ‘first’ indication mentioned earlier. However, the actual relevance indication may also comprise ambiguous theory-evidence relationships in which there is more than one right answer and also room for assigning partial marks to answers that are sub-optimal but not wholly wrong. Further, in more advanced RCQs involving ambiguous theory-evidence relationships marking of such relationships can be made dependent on the assessment of other ambiguous theory-evidence pairs.

Stage 2

Marking of Stage 2 by processor 102, that is, determining a learning credit indicative of the learning progress of the learner, is dependent on answers to Stage 1. A learner's answer to Stage 2 is assessed for three things:

1) Correctness of the judgement regarding a theory's truth.

2) Consistency of the judgement about a theory's truth with the evidence the learner derived regarding that theory in Stage 1 as distinct from consistency with the ideal answer provided by the teacher.

3) Whether evidence the learner identified as being particularly important would, in fact, support their earlier conclusion independently of the truth of that conclusion and given the way the evidence had been treated by the learner in Stage 1.

In one example, processor 102 distinguishes 16 distinct answering patterns for Stage 2, checking for different factors in each pattern. Throughout a significant focus is on assessing the connections between the answers in Stage 2 and earlier answers in Stage 1.

### Example 1

The second indication stored on database 118 indicates that theory A is true but the third indication received from the learner indicates that the learner made some errors in handling the evidence and so concludes, wrongly but consistently, that Theory A is false, which is reflected by the fourth indication received by processor 102. While processor 102 will determine the learning credit such that no marks are awarded for the learner's assessment of the correctness of Theory A, processor 102 will award marks for consistency. Further, in this scenario processor 102 may further modify the learning credit, that is, the mark (positively or negatively) by determining which evidence the learner took to be most important based on the received selection of one or more evidence items.

For instance, the evidence that was incorrectly assessed in Stage 1 appearing on the list of important evidence in Stage 2 is reason to attribute a higher degree of coherence to the learner's thought. This could be used by processor 102 to further increase a learner's mark.

### Example 2

The second indication stored on database 118 indicates that theory A is true and the fourth indication indicates that the theory is identified as true by the learner. However, the third indication indicates that the learner has made several mistakes in Stage 1 and so their answer in Stage 2 is inconsistent with their own (erroneous) assessment of the evidence. Further, the learner's identification of Theory A as true is incoherent—they have selected evidence of little real value as being important. This provides a reason to believe that the learner does not fully understand the evidence and may have been guessing. Processor 102 will award less than full marks in this example.

Subtlety

The marking of Stage 2 in particular demonstrates considerable scope for a thorough assessment of learner performance across a range of learning outcomes. This goes well beyond simply defining answers as either ‘right’ or ‘wrong’. If there is genuinely ambiguous relationship in the evidence then it is even possible for there to be more than one ‘optimal’ response to each of the four main components of Stage 2. While the correctness of an answer is a factor in the overall assessment there are other factors independent of this.

Further, relative weighting of answers stored on database 118 provides an opportunity to bias marks towards specific learning outcomes. For instance, as most analysis happens in Stage 1 and most evaluation in Stage 2, changing the relative weighting of Stages 1 and 2 allows a teacher to bias evaluation over analysis (or vice versa). Further, individual components of Stage 2 can be weighted more heavily to allow for a focus on a particular learning outcome. For example synthesis could be prioritized by assigning more marks to strict consistency in Stage 2.

Establishment

Despite the subtlety of the way processor 102 marks the RCQ the marking rules themselves are built into the exercise. In order to set up the marking rubric the teacher defines the correct relationship for each theory-evidence pair and ranks the evidence sets in order of importance relative to each theory. Once this is done the marking can be entirely automated, allowing for significant time saving in contexts of large-scale education and assessment.

Feedback (See Sample Provided in Diagram 3)

Content-Specific Detail

Processor 102 may generate feedback for each of the theory-evidence pairs as each of these pairs will deal with a specific aspect of content. This feedback can be provided in response to the learner's actual answers, confirming areas understood well and pointing out areas for further development.

Overall Cognitive Traits Identifiable

Feedback can also be written in advance for Stage 2 and stored on database 118 as text string in a table named ‘feedback’. The feedback may focus less on individual content areas and on more general features of a learner's understanding, such as their ability to marshal evidence for an argument and sensitivity to evidence in forming conclusions.

Adaptability/Flexibility

Content Neutrality

The question form is content neutral and as a result the systems and methods described herein can be applied to a variety of different disciplines as mentioned above.

Tailoring to Required Academic Level

There is scope for both biasing the exercise towards specific learning outcomes (see ‘Subtlety’ above) and making the exercise overall more or less challenging. For example, database 118 stores theory-evidence pairs that have genuinely ambiguous relationships, making the exercise more challenging. Alternately, learners can be informed in advance how many of each type of relationship there is in Stage 1, providing a way of further checking their answers before moving on to Stage 2, making the exercise more manageable.

Delivery Mode

While the RCQ may be implemented in an online context, such as Moodie, it is to be understood that the questions themselves can be displayed on paper. The input module described above can then be a scanner and the processor first determines the answer data comprising the third indications, the fourth indication and the selection using optical pattern recognition, such as identifying checked boxes on the answer sheets. Once the answer data is determined and available from data memory 106, the processor 102 determines the learning credit as described above.

Display Issues on Small/Low Resolution Screens

In one example, the learner can see all their Stage 1 answers when answering Stage 2 and therefore, the answers are displayed in a specific way. At this stage it is advantageous to display the questions on a screen with a resolution of at t least 768 vertical pixels. However, in other examples, the user interface may be split into multiple screens and may be presented as part of an App installed on a smart phone, tablet of phablet device using an App provider, such as Google Play or Apple App Store.

Independent Marking Software

While an RCQ can be displayed to a learner in Moodie (and potentially within other similar platforms) a third party marking system that can extract the relevant information from the Moodie database and return answers to students may be used to implement the system. In another example, the marking logic as discussed in detail below may be implemented as Python source code within the Moodie environment and communicating with the website via AJAX.

The following description provides a detailed example of the marking logic stored as executable instructions on program memory 104 and executed by processor 102.

### DEFINITIONS AND BRIEF EXPLANATION

At the beginning of an RCQ a student is presented with four theories and nine evidence statements that can be used to support or undermine a theory. The student matches the provided evidence to each theory and, using the results of this matching exercise, determines whether the theory is true and why. In Stage 1 the student deals solely with the evidential relationships between the theories and evidence. In Stage 2 the student reflects on their previous answers and makes final assessments about the truth or falsity of the theories as well as why each is true or false.

Stage 1 of the RCQ involves the student filling out answers in a 4×9 grid. Each cell in the grid represents the possible evidential relationship between a Theory (represented in columns) and an evidence statement (represented in rows). There are three possible evidential relationships: Use, Ignore, Avoid. The student decides what relationship holds for each Theory-evidence pair and marks that relationship in the appropriate cell. Student's answers are marked relative to the author-defined answers.

The following definitions provide examples of variable names and numbering that may be used in executable program code stored on program memory 104:

Columns are marked A-D, rows 1-9. A cell in the grid is identified by column and row.

A_n_value refers to the correct value for the relationship between theory A and evidence statement n as defined by the author, which is referred to as the actual relevance indication above. It takes the possible values: Use, Ignore, Avoid.

Variables below are defined explicitly for theory A only. Changing A to B in the variable name indicates that theory B is being considered, etc.

A_n_s refers to the student's answer connecting the n-th evidence statement with theory A, which is referred to as third indication above. It takes the possible values: Use, Ignore, Avoid, or Blank.

Importance refers to the relative importance of an evidence statement relative to a theory and others of its actual type (Use, Ignore, Avoid). It takes two possible values: Central and Peripheral. The author defines importance after defining A_n_value, explicitly marking only the Central or Peripheral element and assuming that the importance is relative to whichever of Use, Ignore or Avoid that the evidence statement has already been marked as.

S1_mark is the mark awarded for correctly assessing the evidential relationship between a given Theory and evidence statement.

Stage 2 of the RCQ involves the student assessing the truth of the provided theories and also selecting which single piece of evidence they judge to be most important in supporting the truth of their judgement. This Stage breaks down into two sub-stages, 2a and 2b. In 2a a student marks whether they regard each theory as being true. These answers are assessed in light of the author-defined answers. In Stage 2b the student selects a key piece of evidence that they regard as being most important in coming to their conclusion. Taking this selection and looking back at the pattern of answers a student has already selected, along with information about the relative importance of pieces of evidence as regarded by the teacher where appropriate, allows for an overall assessment of the student's responses to be made.

The grounds for this assessment depend on the actual truth of the theory, the student's assessment of the truth of the theory, the strict consistency of the student's answer with previous selections as well as more complex judgements about how well these selections fit together overall. There are eight basic scenarios into which processor 102 sorts student responses, with anywhere from 4 to 7 outcomes within each scenario. Within each scenario processor 102 can award one of five possible marks. In total 45 distinct outcomes are distinguished.

A_Status indicates whether a theory A is True or False as defined by the author, which is referred to as the second indication above. It takes the values True or False.

A_Status_answer indicates the student's answer regarding the truth status of Theory A, which is referred to as the fourth indication above. It takes the values True or False.

Key evidence selection is the evidence statement a student selects as being most important in supporting his answer regarding the truth status of the Theory under discussion. It ranges from 1 to 9 and takes its values (Use, Ignore, Avoid) from A_n_s, not A_n_value. That is, its value is determined by the students' answers, not the actual values as defined by the answers. However, much of the marking requires comparing the value of the key evidence selection with the actual value of that piece of evidence as defined in A_n_value. Where this occurs the answers as defined by the author will be referred to as the actual value and answers by the student as the judged values.

S2a_mark is the mark awarded for correctly assessing the truth status of a Theory.

S2b_max_mark is the mark awarded for having a completely coherence selection of evidence and truth assessment of the given Theory.

S2b_mid_mark is the mark awarded for having a partially coherent selection of evidence and truth assessment of the given Theory.

S2b_bad_mark is the mark awarded for their being negative coherence in the selection of evidence and truth assessment of the given Theory.

S2b_low_mark is the mark awarded for their being minimal coherence in the selection of evidence and truth assessment of the given Theory. It is a small negative mark.

S2b_very_bad_mark is the mark awarded for their being strong negative coherence in the selection of evidence and truth assessment of the given Theory. It is a large negative mark.

Notes

Throughout this description the answers defined by the author will be referred to as the ‘actual’ values. Selections made by the student will be referred to as the ‘judged’ values.

Explanatory text has been provided under each scenario that captures informally what the program code executed by processor 102 is attempting to do.

Correctness in assessment of the truth-value of a theory is defined as agreement with the view of the question author (the teacher).

Values for the mark-related variables listed above are easily modifiable and stored somewhere for easy access, such as in a Moodie database.

Consistency between the answer about the truth-value of a theory and the evidence is considered relative to the evidence the learner has generated after completing Stage 1, not what the evidence actually says (as judged by the teacher). Consistency is not marked directly but is an important factor in determining what scenario the answers falls within and hence what factors count as relevant evidence when assessing coherence.

Assessments for coherence in the selection of evidence are made in response both to the answer provided about the truth-status of the theory, the actual truth-status, and the consistency of the answer. There are eight distinct scenarios possible in student's answers and between four and seven distinct outcomes within each category.

There are five possible outcomes, not all are available in each category. The five outcomes are: awarding full marks, awarding high partial marks, awarding low partial marks, awarding small negative marks, awarding large negative marks.

A student may not be allowed to pick all Ignore for a theory in Stage 1 as this makes answering Stage 2 consistently impossible. Students will be given the ‘hint’ that at least one theory-evidence pair for each theory is either Use or Avoid.

All sets of evidence are divided into two sub-categories relative to both a Theory and the actual evidential relationship between the Theory and evidence statement as determined by the author. The two categories are ‘Central’ and ‘Peripheral’. Each evidence item has one of these values. This importance indication is also stored on database 118 associated with each of the evidence items.

Marking Rules as implemented as executable instructions and executed by processor 102.

Stage 1

For each cell in the 4×9 grid, where A_n_value=A_n_s award a mark of S1_mark

For each cell in the 4×9 grid, where A_n_value≠A_n_s award a mark of 0

Maximum mark possible=36*(S1_mark)

Stage 2a

For each Theory, where A_Status=A_Status_answer apply a mark of S2a_mark

For each Theory, where A_Status≠A_Status_answer apply a mark of 0

Maximum mark possible=4*(S2a_mark)

Stage 2b

NOTE: where a student response meets the criteria for more than one outcome within a scenario their answer should be regarded as meeting the criteria for which the highest number of marks is awarded. The outcome within a scenario that a response fits into will be used to generate some aspects of the feedback so which outcome a student's answer falls within needs to be recorded for feedback purposes.

Scenario 1: A_Status=True, A_Status_answer=A_Status, none of A_n_s=Avoid

(Student is correct about theory and answer is strictly consistent.)

a) IF (key evidence selection is actually ‘Use’, and the key evidence selection is judged ‘Use’, and the key evidence selected is of actual ‘Central’ importance), THEN award S2b_max_mark

(Full marks if a student's selects the most important or ‘Central’ evidence from among that evidence which is strictly consistent with his assessment of the truth of the Theory. When this is the case the student is unlikely to be approaching the exercise in a purely mechanical way.)

b) IF (and key evidence selection judged ‘Use’, and key evidence selection actually ‘Use’, and the key evidence selected is of actual ‘Peripheral’ importance, and among selections judged ‘Use’ no selection is both actually ‘Use’ and of ‘Central’ importance) THEN award S2b_max_mark

(Full marks if a student's answer is consistent and the student is choosing the best evidence available to them given their earlier selections, even if that answer is Peripheral rather than Central. The student is not punished twice for making an error in Stage 1 regarding what the most important evidence really is.)

c) IF (and key evidence selection judged ‘Use’, and key evidence selection actually ‘Use’, and the key evidence selected is of actual ‘Peripheral’ importance, and among selections judged ‘Use’ at least one selection is both actually ‘Use’ and of ‘Central’ importance) THEN award S2b_mid_mark

(High partial marks for selecting evidence that is genuinely relevant but which is not the best available evidence the student has at their disposal. Here the student has missed evidence which given their previous selections they should have judged as being more important.)

d) IF (key evidence selection is judged ‘Use’, and no selection is both judged ‘Use’ and actually ‘Use’) THEN award S2b_low_mark

(Minimal marks awarded for student can act consistently even when choosing evidence as important that they should have ignored, provided that after these selections they do not have available any evidence which would be better than the evidence that they have chosen. They have made several errors in understanding the evidence but have at least put their misunderstanding together consistently and are at least trying to complete the exercise.)

e) IF (key evidence is judged ‘Use’, and key evidence selection is not actually ‘Use’, and at least one selection is both judged ‘Use’ and actually ‘Use’) THEN award mark of S2b_bad_mark

(Here the student has acted consistently but that counts for little as there they are incorrect about the evidence they regard as important while ignoring other evidence that they did correctly select. Their consistency seems coincidental, or at least not fully understood. Small number of marks lost.)

f) IF (key evidence selection is not judged ‘Use’) THEN award S2b_very_bad_mark

(Take large number of marks away if a student picks evidence as being important that cannot possibly, by the students own judgement, provide any support for their answer. In this case the student is picking evidence that they regard as irrelevant.)

Scenario 2: A_Status=True, A_Status_answer=A_Status, at least one of A_n_s=Avoid

(Student is correct about theory but answer is not strictly consistent.)

a) IF (key evidence selected is judged ‘Use’, and key evidence selected is both actually ‘Use’ and actually of ‘Central’ importance) THEN award a mark of S2b_max_mark)

(Full marks if student overrides the disconfirming evidence by focusing on the relevant and genuinely important confirming evidence.)

b) IF (key evidence selection is judged ‘Use’, and key evidence selection is both actually ‘Use’ and of ‘Peripheral’ importance, and among selections judged ‘Use’ no selections are both actually ‘Use’ and of ‘Central’ importance) THEN award a mark of S2b_mid_marks

(High partial marks are awarded even if a student doesn't select the absolute best evidence provided that they don't overlook any of their own evidence that is more important that the evidence they actually select. This differs from Scenario 1 b because here the student needs to override disconfirming evidence, which places stricter criteria on what would count as a sufficient reason to affirm the theory.)

c) IF (key evidence selection is judged ‘Use’, and key evidence selection is actually ‘Use’ and of ‘Peripheral’ importance, and some evidence judged ‘Use’ is both actually ‘Use’ and actually of ‘Central’ importance) THEN award a mark of S2_b_low_mark

(Overriding disconfirming evidence for poor reasons, which is especially problematic given the availability of good reasons that have for some reason been overlooked.)

d) IF (key evidence selection is judged ‘Use’ and key evidence selection is not actually ‘Use’, and no selection is both judged ‘Use’ and actually ‘Use’) THEN then award a mark of S2b_low_mark

(Answer is minimally consistent and student hasn't ignored any more important evidence but is still acting on evidence that they should have ignored or avoided.)

e) IF (key evidence is judged ‘Use’, and key evidence selection is not actually ‘Use’, and there is at least one selection which is both judged ‘Use’ and is actually ‘Use’) THEN apply a mark of S2b_bad_mark

(Student's answer is minimally consistent but is ignoring much better available evidence. They seem to be selecting for consistency with little thought. A small number of marks lost.)

f) If (key evidence selection is not judged ‘Use’) THEN award 2b_very_bad_mark

(Take a large number of marks away if a student picks evidence as being important that cannot possibly, by the students own judgement, provide any support for their answer.

In this case the student is picking evidence that they regard as irrelevant.)

Scenario 3: A_Status=True, A_Status_answer≠A_Status, at least one of A_n_s=Avoid

(Student is wrong about the truth of the theory but is minimally consistent. That is, they have made errors about the evidence but have followed through on those errors to a consistent, but wrong, conclusion.)

a) IF (no selection judged ‘Use’ is both actually ‘Use’ and of ‘Central’ importance, and there are no selections judged ‘Use’ that are not actually ‘Use’, and key evidence selection is judged ‘Avoid’) THEN award mark of S2b_max_mark

(The student has made a mistake in the evidence and missed the key confirming evidence. With this evidence unavailable and some Avoids seemingly present there is little choice but think the theory false, which is what they have done. Important that they aren't over-selecting ‘Use’ and so are seeing a minimal set of confirming evidence.)

b) IF (key evidence selection is judged ‘Avoid’, and there is no selection judged ‘Use’ that is both actually ‘Use’ and of ‘Central’ importance) THEN award a mark of S2b_mid_mark

(Student has wrongly selected a large amount of evidence for their conclusion and little or no compelling evidence against it but has then followed through consistently. Unlikely to be mere mechanical consistency.)

c) IF (key evidence selection is judged ‘Avoid’, and at least one selection judged ‘Use’ is both actually ‘Use’ and actually of ‘Central’ importance) THEN award a mark of S2b_low_mark

(The student has selected evidence that should indicate the theory is true and should have prompted further reflection. Further reflection didn't seem to happen.)

d) IF (key evidence selection is judged ‘Avoid’ and not more than three selections judged ‘Use’) THEN award mark of S2b_low_mark

(Student sees disconfirming evidence and not very much confirming evidence. Award minimal marks for consistency.)

e) IF (key evidence selection is judged ‘Avoid’, and more than one selection judged ‘Use’ is of ‘Central’ importance THEN award mark of S2b_bad_mark

(Take marks away for the case in which the student has selected a significant amount of evidence that should indicate further reflection on the answer is required.)

f) IF (key evidence selection judged ‘Avoid’ and more than three selections judged ‘Use’) THEN award a mark of S2b_bad_mark

(Here the student sees much confirming evidence which, by the own judgement, should have prompted further reflection. There is no evidence that such reflection happened.)

g) IF (key selection not judged ‘Avoid’) THEN award mark of S2b_very_bad_mark)

Scenario 4: A_Status=True, A_Status_answer≠A_Status, none of A_n_s=Avoid

(Student is wrong about the truth of the theory and their answer is also inconsistent. That is, they have made errors about the evidence but have not followed through on those errors to a consistent, but wrong, conclusion.)

a) IF (key evidence selection judged ‘Ignore’, and among selections judged ‘Use’ no selections are both actually ‘Use’ and of ‘Central’ importance) THEN award mark of S2b_mid_mark

(To have some confidence in student's answer need to know that the student is not picking evidence they regard as confirming and the confirming evidence they see is not overwhelmingly important. Even so, can give at most partial marks, not full marks as the scenario itself implies a lack of proper reflection.)

b) IF (key evidence selection judged ‘Ignore’, and among selections judged use there is at least one selections that is both actually ‘Use’ and actually of ‘Central’ importance, and no more than three evidence selections are judged ‘Use’) THEN award mark of S2b_low_mark

(Here the student has at least one piece of evidence available which should clearly indicate the truth of the theory. While answer is not wholly bad it is only minimally good.)

c) IF (key evidence selection judged ‘Ignore’, and among selections judged ‘Use’ there is at least one selection that is both actually ‘Use’ and actually of ‘Central’ importance, and more than three evidence selections are judged ‘Use’) THEN award a mark of S2b_bad_mark

(Here the student sees many pieces of evidence against their answer, some of which are genuinely important. Yet they persist in an inconsistent answer, showing that no reflection and revision in light of evidence is occurring.)

d) IF (Key evidence selection judged ‘Use’) THEN award a mark of S2b_very_bad_mark

Scenario 5: A_Status=False, A_Status_answer=A_Status, at least one of A_n_s=Avoid

(Student is correct about the falsity of the theory and their answer is also strictly consistent with their evidence selections. This is promising but need to confirm that the student is basing their answer on the best reasons.)

a) IF (key evidence selection judged ‘Avoid’, and key evidence selection actually ‘Avoid’, and key evidence selection of ‘Central’ importance) THEN award mark of S2b_max_mark

(Full marks if the student correctly recognizes the theory to be false and also indicates that they have come to this conclusion for the best reasons.)

b) IF (key evidence judged ‘Avoid’, and key evidence selection is actually ‘Avoid’, and key evidence selection of ‘Peripheral’ importance, and among selections judged ‘Avoid’ no selection is both actually ‘Avoid’ and of ‘Central’ importance) THEN award mark of S2b_max_mark

(Award full marks even when best evidence not selected provided that among all the evidence the student sees there is no evidence better than that which have actually selected.)

c) IF (key evidence judged ‘Avoid’, and key evidence selection is actually ‘Avoid’, and key evidence selection of ‘Peripheral’ importance, and among selections judged ‘Avoid’ at least one selection that is both actually ‘Avoid and of ‘Central’ importance) THEN award mark of S2b_mid_mark

(High partial marks for selecting as important evidence that is genuinely confirming but which is not the absolutely best available evidence that could be chosen given the evidence that the student actually has in front of them.)

d) IF (key evidence selection judged ‘Avoid’, and no selection is both judged ‘Avoid’ and actually ‘Avoid’) THEN award mark of S2b_low_mark

(Low positive marks for being minimally consistent provided that the student has not missed any better evidence from among the set they have available after their Stage 1 selections.)

e) IF (key evidence judged ‘Avoid’, and key evidence selection is not actually ‘Avoid’, and at least one selection is both judged ‘Avoid’ and actually ‘Avoid’) THEN award mark of S2b_bad_mark

(Here the student is minimally consistent but has only achieved this at the expense of overlooking evidence available to them which is of greater importance. So their mere minimal consistency, which could have been achieved mechanically, doesn't count for anything and actually in context counts against them.)

f) IF (key evidence selection not judged ‘Avoid’) THEN award a mark of S2b_very_bad_mark

Scenario 6: A_Status=False, A_Status_answer=A_Status, none of A_n_s=Avoid

(Student is correct about the falsity of the theory but their answer is not strictly consistent with their evidence selections. That is, they haven't picked any disconfirming evidence for the theory even though they think it is false. Impossible to regard this answer as fully coherent under any circumstances.)

a) IF (key evidence selection judged ‘Ignore’, and no selections judged ‘Use’ are actually ‘Use’) THEN award mark of S2b_mid_mark

(Provided that the student isn't selecting confirming evidence and also isn't seeing any overwhelmingly important confirming evidence award some but not full marks. This is the best possible outcome given earlier selections.)

b) IF (key evidence selection judged ‘Ignore’, and at least one selection judged ‘Use’ is both actually ‘Use’ and of ‘Peripheral’ importance, and among selections judged ‘Use’ no selection is both actually ‘Use’ and of ‘Central’ importance) THEN award a mark of S2b_low_mark

(The student's already inconsistent answer is further undermined by the presence of weakly confirming evidence that should have been enough to prompt the student to reflect further on, and change, their previous answers. However this isn't as bad as it could be, as the evidence here is still only weakly confirming.)

c) IF (key evidence selection is judged ‘Ignore’, and among evidence selections judged ‘Use’ at least one is both actually ‘Use’ and of ‘Central’ importance) THEN award a mark of S2b_bad_mark

(Student's answer makes little sense in light of confirming evidence they have selected. Student seems to be coming to their conclusion explicitly against the evidence they have before them.)

d) IF (key evidence selection not judged ‘Ignore’) THEN award a mark of S2b_very_bad_mark

(Student's answer makes no sense at all. They are picking evidence which they regard as indicating the truth of the theory as being important for theory being false. At best they are guessing unluckily.)

Scenario 7: A_Status=False, A_Status_answer # A_Status, none of A_n_s=Avoid

(Student is wrong about the falsity of the theory but their answer is at least strictly consistent with their evidence selections, in that they haven't picked any disconfirming evidence and so if following through on selections would have to think the theory true.)

a) IF (key evidence selection judged ‘Use’, and key evidence selection is both actually ‘Use’ and of ‘Central importance’) THEN award mark of S2b_max_mark

(Student gets full marks for selecting the best possible available evidence for their conclusion. Even though they have made previous errors about that evidence those errors now force them to the conclusion they have chosen.)

b) IF (key evidence selection judged ‘Use’, and key evidence selection both actually ‘Use’ and of ‘Peripheral’ importance, and among selections judged ‘Use’ no selection is both actually ‘Use’ and of ‘Central’ importance) THEN award mark of S2b_max_mark

(Student has not selected the best possible evidence according to the author but has selected the best available evidence given their previous selections. Given the number of errors that have led to this scenario it is unlikely that the student is selecting important evidence at random, some understanding is shown here.)

c) IF (key evidence selection is judged ‘Use’, and key evidence selection is both actually ‘Use’ and of ‘Peripheral’ importance, and among selections judged ‘Use’ there is at least one selection that is both actually ‘Use’ and of ‘Central’ importance) THEN award a mark of S2b_low_mark

(The student has ignored better evidence that they have previously recognized as being pertinent when coming to their conclusion. Acting consistently but not as well as they could be in this context.)

d) IF (key evidence selection is ‘Use’, and no selection is both judged ‘Use’ and actually ‘Use’) THEN award mark of S2b_low_mark

(Award some marks even if the evidence selected as important is not genuine, provided that no genuine evidence was available for selection. They have acted consistently and haven't overlooked any evidence that they should have attended to, given their previous selections.)

e) IF (key evidence selection is judged ‘Use’, and key evidence selection is not actually ‘Use’, and at least one evidence selection is both judged ‘Use’ and actually ‘Use’) award mark of S2b_bad_mark

(Take marks away if the evidence selected as most important is not actually relevant in the context of there being genuinely relevant evidence available given previous selections.)

f) If (key evidence selection is not judged ‘Use’) THEN award a mark of S2b_very_bad_mark

Scenario 8: A_Status=False, A_Status_answer # A_Status, at least one of A_n_s=Avoid

(Student is wrong about the truth of the theory and is also inconsistent. That is, they think the theory is true but have picked evidence indicating that it is false.)

a) IF (key evidence selection is judged ‘Use’, and key evidence selection is both actually ‘Use’ and of ‘Central’ importance, and among evidence selections judged ‘Avoid’ no evidence selection is both actually ‘Avoid’ and of ‘Central’ importance, and no selection judged ‘Avoid’ is actually ‘Use’, and no selection judged ‘Ignore’ is actually ‘Use’) THEN award mark of S2b_max_mark

(The student has made mistakes but seems to realize that is was a mistake at least enough not to be distracted by it. They are picking the best available evidence to support their position and is not seeing any evidence that would very clearly indicate an error given previous selections. They have also found all the real confirming evidence for their conclusion.)

b) IF (key evidence selection is judged ‘Use’, and key evidence selection is both actually ‘Use’ and of ‘Central’ importance, and among evidence selections judged ‘Avoid’ at least one evidence selection is both actually ‘Avoid’ and of ‘Central’ importance, and no selection judged ‘Avoid’ is actually ‘Use’, and no selection judged ‘Ignore’ is actually ‘Use’) THEN award mark of S2b_mid_mark

(Here the student is seeing and selecting evidence that really would indicate that their answer is wrong but has at least found all the confirming evidence and made important the best available evidence.)

c) IF (key evidence selection is judged ‘Use’, and key evidence selection is both actually ‘Use’ and of ‘Central’ importance, and among evidence selections judged ‘Avoid’ no evidence selection is both actually ‘Avoid’ and of ‘Central’ importance, and at least one selection not judged ‘Use’ is actually ‘Use’) THEN award mark of S2b_mid_mark

(Student has selected genuinely useful evidence and isn't seeing any decisive disconfirming evidence but has missed some confirming evidence, which in the context of being wrong does matter. Not full marks.)

d) IF (key evidence selection is judged ‘Use’, and key evidence selection is both actually ‘Use’ and of ‘Central’ importance, and among selections judged ‘Avoid’ at least one selection is both actually ‘Avoid’ and of ‘Central’ importance) THEN award a mark of S2b_low_mark

(The student has identified reasons which should appear to him to indicate that he is wrong about the truth of the theory but has at least chosen to override this evidence with good reasons.)

e) IF (key evidence selection is judged ‘Use’, and key evidence selection is not actually ‘Use’, and among selections judged ‘Avoid’ not selection is actually ‘Avoid’) THEN award mark of S2b_bad_mark

(Student has not selected any decisive evidence in their favor and has selected evidence that tells against their position. Cannot really have good reasons for their position and is still inconsistent.)

f) IF (key evidence selection is judged ‘Use’, and key evidence selection is not actually ‘Use’, and among evidence selections judged ‘Avoid’ at least one selection is actually ‘Avoid’) THEN award mark of S2b_very_bad_mark

Provided below is an example feedback form that the processor 102 generates and presents to the user after automatically determining the learning credit.

Stage 1

Each question in Stage 1 of the RCQ asks about a specific aspect of the subject content. The graph below shows how well you have understood that content overall. Below the graph are tables that group together the aspects of the subject addressed in Stage 1 that you understand well, aspects that you partially understand and aspects that you do not yet understand.

Subject Content Well Understood (Notes Reference are Provided)

The symbolic significance of blood in the Levitical sacrificial system

OT1 7.4.1

The ‘contagious’ nature of sin within the Levitical sacrificial system

OT1 7.2.4

The proscribed ways of becoming holy, clean and unclean in the Levitical sacrificial system

OT1 7.5.2

The methods of restoring relationships in the Levitical sacrificial system

OT1 7.5.4

The persistent nature of sin in the Levitical sacrificial system

OT1 7.1.3

Subject Content Partially Understood

The partially arbitrary nature of the Levitical sacrificial system

OT1 7.4.3

The symbolic significance of reproduction in the Levitical sacrificial system

OT1 7.4.2

The implications of the tabernacle being profaned

OT1 7.6.2

Subject Content Not Yet Understood

The symbolic significance of holinesss in the Levitical sacrificial system

OT1 7.4.3

Stage 2—Assessment of theoretical claims against evidence

Theory A (Adam's theory)

Your assessment of the theory was correct. However you didn't identify all the most important evidence for this theory as you missed some of this evidence in Stage 1. Despite this your answer was consistent with your previous answers.

Theory B (Bills theory)

Your assessment of the theory was correct. However your answer was not consistent with your assessment of the evidence. It appears that your theological intuitions are sound but you cannot yet always marshal evidence reliably for your conclusions. Your answer would have been better had the inconsistency led you to either reconsider the evidence.

Theory C (Carol's theory)

Your assessment of the theory was incorrect. However your answer was consistent with your assessment of the evidence—because you made some mistakes with the evidence. While it is commendable to form conclusions based on evidence it is also important to have a firm grasp of the truth that can alert us to situations when evidence is likely to be misleading. Your grasp of the truths concerning the Levitical sacrificial system is not yet as strong as it could be.

Theory D (Doris' theory)

Your assessment of the theory was correct. You also identified all the relevant evidence and your conclusion about the theory was consistent with the evidence you gathered. In this case your answer was ideal.

Overall

Your accuracy in assessing the evidence was mixed—some errors were made. Your assessment of the truth of the theories was good but not yet ideal overall. Your ability to evaluate theories in the light of evidence could be further improved as some inconsistencies were evident. Overall you have done well but there is room for development.

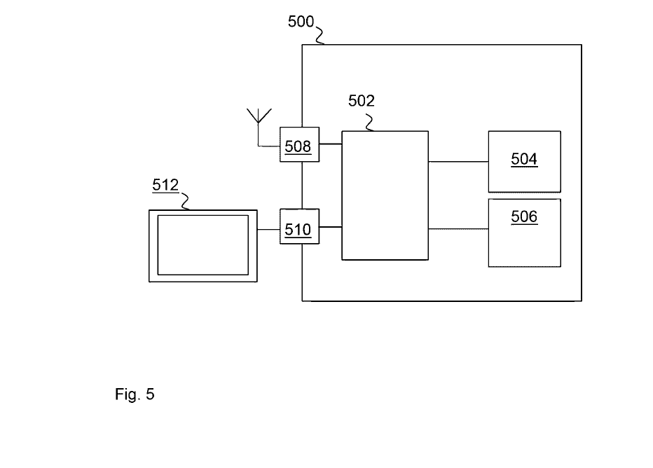

FIG. 5 illustrates a computer system 500 for generating user interface 300 of FIG. 3 to assess learning of a user. Computer system 500 is similar to computer system 100 in FIG. 1 and comprises a processor 502 connected to program memory 504, data memory 506, input data port 508, such as a Wi-Fi or other Internet connection, user port 510 and display device 512.

Processor 102 receives through input data port 108 multiple electronic evidence items and an electronic representation of a theory, such as a string of ASCII characters.

Processor 102 generates a user interface 300 as shown in FIG. 3 and displays user interface 300 on display 512. As explained with reference to FIG. 3, the user interface comprises a representation of the multiple electronic evidence items 302 and the theory 306. The user interface 300 generated by processor 502 further comprises a first user control element 304 associated with each of the multiple electronic evidence items 302 to allow the user to provide the judged relevance indication of the relationship between that electronic evidence item and the theory and a second user control element 308 associated with the theory 306 to allow the user to provide the judged truth indication of whether the theory is correct.

In this example, input data port 508 is bi-directional and also serves as an output data port to send the judged relevance indication associated with each of the multiple electronic evidence items and the judged truth indication to an assessment computer system, such as computer system 100 in FIG. 1.

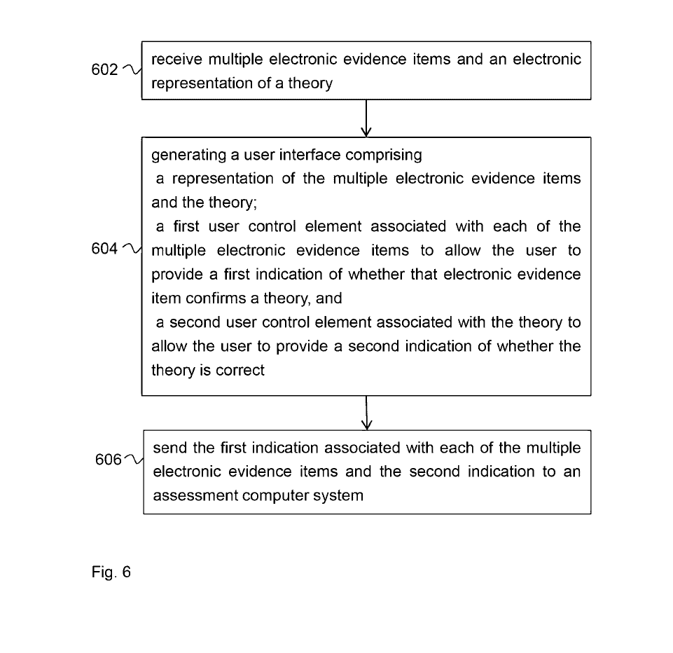

FIG. 6 illustrates a computer implemented method for generating a user interface to assess learning of a user as implemented by executable instructions stored on program memory 104 and performed by processor 502. Processor 502 first receives 602 multiple electronic evidence items and an electronic representation of a theory.

The processor 502 then generates 604 a user interface 300, which comprises the features discussed above of a representation of the multiple electronic evidence items and the theory, a first user control element associated with each of the multiple electronic evidence items and a second user control element associated with the theory.

The processor 502 sends 606 the first indication associated with each of the multiple electronic evidence items and the second indication to an assessment computer system, such as computer system 100.

It will be appreciated by persons skilled in the art that numerous variations and/or modifications may be made to the specific forms illustrated and described herein without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present variations of the present disclosure are, therefore, to be considered in all respects as illustrative and not restrictive.

What is claimed is:

1. A computer system for assessing learning of a user, the computer system comprising:
an input module to receive from the user:
a first indication associated with each of multiple electronic evidence items of a relationship between that electronic evidence item and a theory, and
a second indication of whether the theory is correct; and
a processor:
to determine a learning credit for the second indication based on the first indication associated with each electronic evidence item and the second indication, and
to store on a data store assessment data indicative of the learning credit awarded to the user.

2. The computer system of claim 1, wherein the input module is to further receive a selection of a first of the multiple electronic evidence items and to determine the learning credit is based on the selection of the first of the evidence items.

3. The computer system of claim 1, further comprising a database to store
a third indication associated with each of the multiple electronic evidence items of the relationship between that electronic evidence item and the theory, and
a fourth indication of whether the theory is correct,
wherein to determine the learning credit is based on the third indication associated with each of the multiple electronic evidence documents and the fourth indication.

4. The computer system of claim 3, wherein the processor is further to determine whether the second indication is different from the fourth indication and to determine the learning credit is based on whether the second indication is different from the fourth indication.

5. The computer system of claim 4, wherein the processor is further to identify a second of the multiple electronic evidence items where the first indication is different from the third indication and to determine the learning credit is based on the second of the multiple electronic evidence items.

6. The computer system of claim 5, wherein the processor is further to determine that the first of the multiple electronic evidence items is identical to the second of the multiple electronic evidence items and to determine the learning credit is responsive to determining that the second indication is different from the fourth indication and that the first of the multiple electronic evidence items is identical to the second of the multiple electronic evidence items.

7. The computer system of claim 1, wherein the database is to further store an importance indication associated with each of the multiple electronic evidence items and to determine the learning credit is based on the importance indication.

8. The computer system of claim 1, wherein the first indication of the relationship has one of multiple indication values and the multiple indication values comprise:
a first indication value indicating that the electronic evidence item confirms the theory;
a second indication value indicating that the electronic evidence item disconfirms the theory; and
a third indication value indicating that the electronic evidence item is not related to the theory.

9. A computer implemented method for assessing learning of a user, the method comprising:
receiving from the user
a first indication associated with each of multiple electronic evidence items of a relationship between that electronic evidence item and a theory, and
a second indication of whether the theory is correct;
determining a learning credit for the second indication based on the first indication associated with each electronic evidence item and the second indication; and
storing on a data store assessment data indicative of the learning credit awarded to the user.

10. A non-transitory computer-readable medium, including computer-executable instructions stored thereon that when executed by a processor causes the processor to perform the method of claim 9.

11. A computer system for generating a user interface to assess learning of a user, the computer system comprising:
an input data port to receive multiple electronic evidence items and an electronic representation of a theory;
a processor to generate a user interface, the user interface comprising
a representation of the multiple electronic evidence items and the theory;
a first user control element associated with each of the multiple electronic evidence items to allow the user to provide a first indication of a relationship between that electronic evidence item and a theory, and
a second user control element associated with the theory to allow the user to provide a second indication of whether the theory is correct; and
an output data port to send the first indication associated with each of the multiple electronic evidence items and the second indication to an assessment computer system.

12. The computer system of claim 10, wherein the user interface further comprises a third user control element to allow the user to provide a selection of one of the multiple electronic evidence items.

13. A computer implemented method for generating a user interface to assess learning of a user, the method comprising:
receiving multiple electronic evidence items and an electronic representation of a theory;
generating a user interface comprising
a representation of the multiple electronic evidence items and the theory;
a first user control element associated with each of the multiple electronic evidence items to allow the user to provide a first indication of a relationship between that electronic evidence item and a theory, and
a second user control element associated with the theory to allow the user to provide a second indication of whether the theory is correct; and
sending the first indication associated with each of the multiple electronic evidence items and the second indication to an assessment computer system.

14. A non-transitory computer-readable medium, including computer-executable instructions stored thereon that when executed by a processor causes the processor to perform the method of claim 13.
